(19) United States
(12) Patent Application Publication
(10) Pub. No.: US 2026/0133027 A1
(43) Pub. Date: May 14, 2026

(54) APPARATUS AND METHOD FOR MONITORING THREE-DIMENSIONAL STRAIN IN LANDSLIDE SLIP ZONE

(71) Applicant: CHINA UNIVERSITY OF GEOSCIENCES (WUHAN), Wuhan (CN)

(72) Inventors: Changdong LI, Wuhan (CN); Junrong ZHANG, Wuhan (CN); Dewei HUANG, Wuhan (CN); Xinshuang SUN, Wuhan (CN); Xiaolin YANG, Wuhan (CN); Jie MENG, Wuhan (CN); Yangyuge SUN, Wuhan (CN)

(73) Assignee: CHINA UNIVERSITY OF GEOSCIENCES (WUHAN), Wuhan (CN)

(21) Appl. No.: 19/436,439

(22) Filed: Dec. 30, 2025

(30) Foreign Application Priority Data
Jul. 31, 2025 (CN) 202511069150.2

(51) Int. Cl. G01B 11/16; G01B 21/32

(52) U.S. Cl. CPC G01B 11/16; G01B 21/32

(57) ABSTRACT

An apparatus for monitoring three-dimensional strain in landslide slip zone includes a strain sensor, a data control module, and a magnetic positioning device. The strain sensor includes a protective shell, a slidable rotating cover, a fiber Bragg grating (FBG) sensor, and a telescopic rod. The telescopic rod is configured to push the FBG sensor into contact with a stratum to monitor strain information of soil and rock mass in the slip zone. The data control module is electrically connected to a switch of the slidable rotating cover via data cable and is configured to preprocess data collected by the FBG sensor. The magnetic positioning device is configured to correct displacement detection orientation errors of the FBG sensor caused by landslide deformation.

### CROSS-REFERENCE TO RELATED APPLICATIONS

This application claims priority to Chinese Patent Application No. 202511069150.2 with a filing date of Jul. 31, 2025. The content of the aforementioned application, including any intervening amendments thereto, is incorporated herein by reference.

### TECHNICAL FIELD

The present disclosure relates to the technical field of landslide monitoring, specifically to an apparatus and method for monitoring three-dimensional strain in a landslide slip zone.

### BACKGROUND

Landslides are a common and widely impactful geological hazard, posing serious threats to human life, property safety, and the ecological environment. Before a landslide disaster intensifies or expands, significant changes in stress and strain occur within the landslide body. The redistribution of stress and accumulation of strain gradually alter the mechanical equilibrium state of the landslide body, driving it toward instability. Due to the characteristics of low mechanical strength and high deformability of soil and rock mass in the slip zone, the strain characteristic of the slip zone is of great significance for landslide stability and landslide prevention engineering. Strain data obtained through professional monitoring methods can be used to further analyze the evolution process of landslides, providing critical evidence for landslide prediction and prevention.

Currently, monitoring measures for landslide deformation mainly fall into two categories:

The first method employs traditional single-point strain monitoring, where strain sensors are typically deployed at specific monitoring points to measure strain changes at those points, thereby obtaining relevant information.

The second method uses photogrammetry and image recognition approaches, utilizing handheld scanners, drones, satellites, and other photographic scanning means to identify deformation from captured surface image data of the slope body, with accuracy verified against measurements from total stations.

Although the above methods can monitor strain in specific areas of landslides and identify surface deformation of the landslide, they have certain limitations. For example, the traditional single-point strain monitoring method can only obtain strain information in a single direction, failing to reflect the distribution of the three-dimensional strain field inside the landslide body, and is unsuitable for three-dimensional strain monitoring of the slip zone. Photogrammetry and image recognition approaches primarily target the landslide surface and cannot directly obtain strain conditions inside the landslide, let alone strain in the uniquely positioned slip zone. Additionally, these approaches have long data update cycles, making them unable to meet real-time early-warning requirements.

Considering the complex nature of landslide deformation, existing apparatuses cannot meet the demands for precise three-dimensional strain measurement. Furthermore, strain sensors are prone to environmental interference and damage during installation into the subsurface, limiting the ability of relevant professionals to observe and assess the evolution of landslide hazards.

From a practical standpoint, it is necessary to develop an apparatus for monitoring three-dimensional strain in a landslide slip zone and ensure proper operation of the apparatus. This is of significant importance for landslide disaster prevention, particularly in the observation and research of strain in landslide slip zones.

### SUMMARY OF PRESENT INVENTION

In view of the problems existing in the prior art, the present disclosure provides an apparatus and method for monitoring three-dimensional strain in a landslide slip zone. The method has advantages of high precision, strong anti-interference capability, and capability of remote automatic monitoring, and can significantly improve the accuracy of landslide slip zone monitoring.

To solve the above problems, the first objective of the present disclosure is to provide an apparatus for monitoring three-dimensional strain in a landslide slip zone, which is installed partially in a landslide body and partially in a slip zone, the slip zone is located just below the landslide body, and a bedrock layer is situated below the slip zone, and the apparatus includes:
a strain sensor including a protective shell, a slidable rotating cover covering an opening of the protective shell, a fiber Bragg grating (FBG) sensor located inside the protective shell, and a telescopic rod slidably arranged within the protective shell and the slidable rotating cover, where the telescopic rod is configured to push the FBG sensor into contact with a stratum to monitor strain information of soil and rock mass in the slip zone;
a data control module configured to be arranged on a surface of the landslide body, where the data control module is electrically connected to a switch of the slidable rotating cover via a data cable; the data control module is configured to preprocess data collected by the FBG sensor, save the data in a local database, and transmit the data to a remote monitoring center; and
a magnetic positioning device configured to correct displacement detection orientation errors of the FBG sensor caused by landslide deformation.

Preferably, a plurality of FBG sensors are arranged in the landslide body along axial, 45° oblique, and transverse orthogonal directions, and a calculation expression for a relationship between strains measured by the plurality of FBG sensors and wavelengths is as follows:

$$\{ \begin{matrix}Δ {λ}_{1} = {K}_{11} {ε}_{x} + {K}_{12} {ε}_{y} + {K}_{13} {Υ}_{xy} \\ Δ {λ}_{2} = {K}_{21} {ε}_{x} + {K}_{22} {ε}_{y} + {K}_{23} {Υ}_{xy} \\ Δ {λ}_{3} = {K}_{31} {ε}_{x} + {K}_{32} {ε}_{y} + {K}_{33} {Υ}_{xy}\end{matrix}$$

where Δλ₁ represents a wavelength change detected by the FBG sensors arranged along the axial direction; Δλ₂ represents a wavelength change detected by the FBG sensors arranged along the 45° oblique direction; Δλ₃ represents a wavelength change detected by the FBG sensors arranged along the transverse orthogonal direction; K₁₁, K₁₂, and K₁₃ are coefficients corresponding to the FBG sensors arranged along the axial direction; K₂₁, K₂₂, and K₂₃ are coefficients corresponding to the FBG sensors arranged along the 45° oblique direction; K₃₁, K₃₂, and K₃₃ are coefficients corresponding to the FBG sensors arranged along the transverse orthogonal direction; εₓ represents a tensile/compressive strain of the slip zone along a sensor axial direction; ε_{y} represents a normal strain of the slip zone along a direction perpendicular to a main sliding direction; and γ_{xy} represents a shear strain of the slip zone in an x-y plane.

Preferably, a calculation expression for a three-dimensional strain tensor is as follows:

$$ε = [ \begin{matrix}{ε}_{x} & {η}_{xy} & {η}_{x z} \\ {η}_{x y} & {ε}_{y} & {η}_{y z} \\ {η}_{x z} & {η}_{yz} & {ε}_{z}\end{matrix} ]$$

where η_{xy}, η_{xz}, and η_{yz} represent shear strains in an ij direction; and ε_{z} represents a normal strain of the slip zone along a z-axis direction.

Preferably, a strain-to-stress conversion formula based on the strains measured by the plurality of FBG sensors is expressed as follows:

$$[ \begin{matrix}{σ}_{x} \\ {σ}_{y} \\ {σ}_{z} \\ {τ}_{x y} \\ {τ}_{y z} \\ {τ}_{zx}\end{matrix} ] = \frac{E}{( 1 + v ) ( 1 - 2 v )} [ \begin{matrix}1 - v & v & v & 0 & 0 & 0 \\ v & 1 - v & v & 0 & 0 & 0 \\ v & v & 1 - v & 0 & 0 & 0 \\ 0 & 0 & 0 & \frac{1 - 2 v}{2} & 0 & 0 \\ 0 & 0 & 0 & 0 & \frac{1 - 2 v}{2} & 0 \\ 0 & 0 & 0 & 0 & 0 & \frac{1 - 2 v}{2}\end{matrix} ] [ \begin{matrix}{ε}_{x} \\ {ε}_{y} \\ {ε}_{z} \\ {γ}_{x y} \\ {γ}_{y z} \\ {γ}_{zx}\end{matrix} ]$$

where σₓ represents a normal stress along an x-axis direction; σ_{y} represents a normal stress along a y-axis direction; σ_{z} represents a normal stress along a z-axis direction; τ_{xy} represents a shear stress in the x-y plane; τ_{yz} represents a shear stress in a y-z plane; τ_{zx} represents a shear stress in a z-x plane; E represents an elastic modulus; v represents Poisson's ratio; γ_{yz} represents a shear strain of the slip zone in a y-z plane; and γ_{zx} represents a shear strain of the slip zone in a z-x plane.

Preferably, the FBG sensor includes a cladding and a core located inside the cladding, the cladding is designed as a protective structure with an outer layer, a middle layer, and an inner layer, the inner layer is coated with acrylate, the middle layer is encapsulated with a stainless steel capillary, and the outer layer is covered with a polyurethane sheath.

Preferably, the apparatus further includes:
a fixed casing, configured to be vertically installed in a borehole vertically defined in the landslide body; and
a support structure including a support column vertically inserted into the fixed casing, a limit ring sleeved on a top of the support column, a support frame uniformly and perpendicularly connected around a periphery of the limit ring as an integral part, and a support rod parallel to the support column, with a top end vertically connected to a bottom surface of the support frame, where the top of the support column is fixed to a ground surface of the landslide body via the limit ring, a bottom end of the support column extends into the slip zone and is fixed in the bedrock layer; the support frame is fixed to the ground surface of the landslide body via the support rod; and the FBG sensor is fixed on the support column.

Preferably, the magnetic positioning device includes a fluxgate sensor and a magnetic pole electrically connected to each other, the fluxgate sensor is fixed on the support column and is located directly above the FBG sensor, and the magnetic pole is fixed at a bottom of the FBG sensor.

Preferably, the data control module includes a data box and data interfaces embedded in the data box, the data box is electrically connected to the strain sensor and the magnetic positioning device via a data cable.

Preferably, the apparatus further includes a solar panel installed on a top of the data control module, where the solar panel is electrically connected to the data control module.

The second objective of the present disclosure is to provide a method applied to the above apparatus for monitoring three-dimensional strain in the landslide slip zone, and the monitoring method includes the following steps:
step S₁₀₀: installing the strain sensor, the magnetic positioning device, and the data control module between the landslide body and the slip zone;
step S₂₀₀: during the installation of the strain sensor, keeping the slidable rotating cover of the strain sensor closed, where when the strain sensor is placed in the slip zone, the data control module controls the slidable rotating cover of the strain sensor to open and controls the telescopic rod of the strain sensor to push the strain sensor into contact with the soil and rock mass; and
step S₃₀₀: when deformation of the landslide body causes position changes of the strain sensor, correcting, by the magnetic positioning device, data monitored by the strain sensor.

Compared with the prior art, the present disclosure has the following beneficial effects:

The apparatus for monitoring three-dimensional strain in the landslide slip zone in the present disclosure includes a strain sensor, a data control module, and a magnetic positioning device. Through layered deployment and modular design, the apparatus achieves dynamic three-dimensional strain monitoring of a landslide slip zone. The apparatus is deployed partially in a landslide body and partially in a slip zone, with a bedrock layer below the slip zone. This location selection directly targets a key shear zone (slip zone) of landslide hazards, ensuring that monitoring data can reflect a core area of landslide deformation. During data acquisition and processing, the data control module commands slidable rotating cover to open, and telescopic rod push the fiber Bragg grating (FBG) sensor to be in contact with a slip zone stratum to initiate strain monitoring. The magnetic positioning device can perform precise spatial positioning, assist the strain sensor in detecting displacement, and correct orientation errors caused by landslide deformation. The slidable rotating cover serves as a sensor protective device, preventing disturbance and damage from environmental influences when the strain sensor is installed into the stratum. A multi-stage telescopic structure design ensures timely adjustment of sensor positions. Strain data from the FBG sensor are transmitted to the data control module via data cable, preprocessed, stored in a local database, and then uploaded to a remote monitoring center via wireless communication (e.g., 4G/satellite). The magnetic positioning device outputs sensor spatial orientation data in real time. The data control module combines the original strain data with orientation correction values to generate a corrected three-dimensional strain field. In this method, a three-dimensional measurement apparatus acquires strain data of soil and rock mass in the slip zone from multiple dimensions, facilitating the understanding of strain variations in landslide deformation across both temporal and spatial scales.

### BRIEF DESCRIPTION OF THE DRAWINGS

FIG. 1 is a schematic three-dimensional structural diagram showing an apparatus for monitoring three-dimensional strain in a landslide slip zone according to an embodiment of the present disclosure;

FIG. 2 is a schematic structural diagram showing a strain sensor according to an embodiment of the present disclosure;

FIG. 3 is a schematic structural diagram showing a magnetic positioning device according to an embodiment of the present disclosure;

FIG. 4 is a schematic structural diagram showing a support structure in one direction according to an embodiment of the present disclosure;

FIG. 5 is a schematic structural diagram showing the support structure in another direction according to an embodiment of the present disclosure;

FIG. 6 is a schematic structural diagram showing a slidable rotating cover in one direction according to an embodiment of the present disclosure;

FIG. 7 is a schematic structural diagram showing the slidable rotating cover in another direction according to an embodiment of the present disclosure;

FIG. 8 is a schematic structural diagram showing the apparatus deployed in a landslide body according to an embodiment of the present disclosure; and

FIG. 9 is a schematic flowchart showing a method applied to the apparatus for monitoring three-dimensional strain in the landslide slip zone according to an embodiment of the present disclosure.

### REFERENCE NUMERALS

1—strain sensor;
11—FBG sensor; 111—cladding; 112—core;
12—protective shell; 13—telescopic rod; 14—slidable rotating cover; 141—
slider; 142—fan blade; 143—connecting rod; 144—base; 145—micro rotary motor;
2—data control module;
21—data box; 22—data cable; 23—data interface;
3—magnetic positioning device; 31—fluxgate sensor; 32—magnetic pole;
4—fixed casing;
5—support structure; 51—support column; 52—limit ring; 53—support frame; 54—support rod;
6—solar panel;
7—landslide body; 71—borehole; 8—slip zone; 9—bedrock layer.

### DETAILED DESCRIPTION OF THE EMBODIMENTS

The following clearly and completely describes the technical solutions of the present disclosure with reference to accompanying drawings. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

In the description of the present disclosure, it should be noted that, unless otherwise clearly specified, meanings of terms “install”, “connected with”, and “connected to” should be understood in a broad sense. For example, the connection may be a fixed connection, a removable connection, or an integral connection; may be a mechanical connection or an electrical connection; may be a direct connection or an indirect connection by using an intermediate medium; may be intercommunication between two components; or may be a wired connection or a wireless connection. Those of ordinary skill in the art may understand specific meanings of the foregoing terms in the present disclosure based on a specific situation.

In addition, the technical features involved in the various implementations of the present disclosure described below may be combined with each other as long as they do not constitute a conflict with each other.

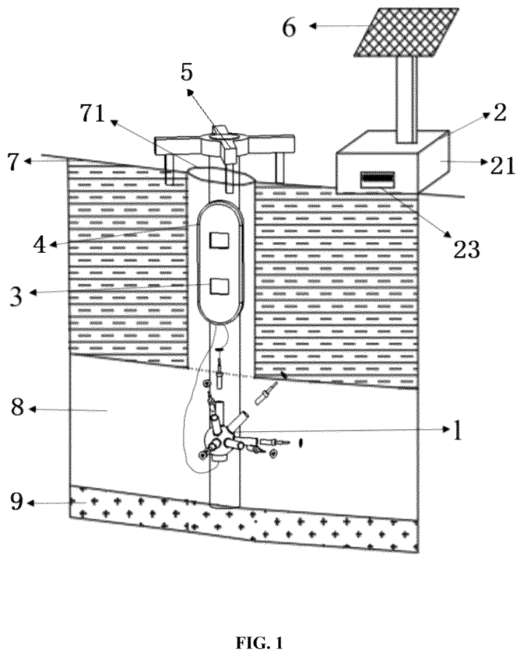

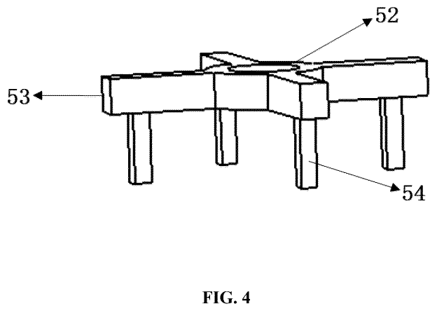

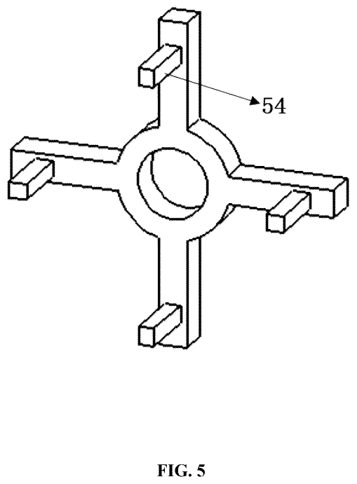

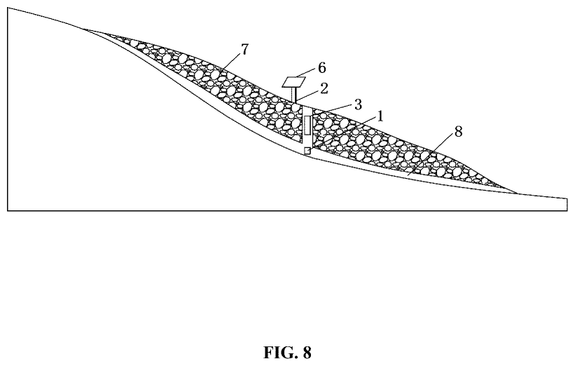

Referring to FIG. 1 to FIG. 8, an embodiment of the present disclosure provides an apparatus for monitoring three-dimensional strain in a landslide slip zone. The apparatus is installed partially in a landslide body 7 and partially in a slip zone 8. The slip zone 8 is located below the landslide body 7, and a bedrock layer 9 is situated below the slip zone 8. Based on geological conditions of the landslide slip zone, the apparatus in this embodiment includes a strain sensor 1, a data control module 2, and a magnetic positioning device 3.

The strain sensor 1 includes a FBG sensor 11, protective shell 12, telescopic rod 13, and slidable rotating cover 14. The slidable rotating cover 14 covers an opening of the protective shell 12, and the FBG sensor 11 is located inside the protective shell 12. The strain sensor 1 directly perceives the strain of soil and rock mass in the slip zone through the FBG sensor 11, and can capture minor deformations with its high-precision characteristics. The telescopic rod 13 is slidably arranged within the protective shell 12 and the slidable rotating cover 14. The telescopic rod 13 can push the FBG sensor 11 to be in contact with a slip zone stratum to monitor strain information of the soil and rock mass in the slip zone. The protective shell 12 provides physical protection. The slidable rotating cover 14 protects the FBG sensor 11 during installation and sensor position adjustment through the pushing action of the telescopic rod 13.

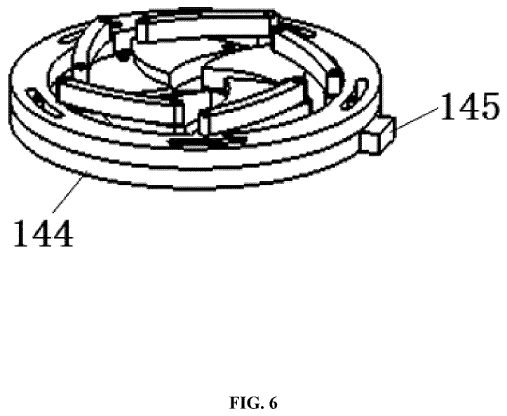

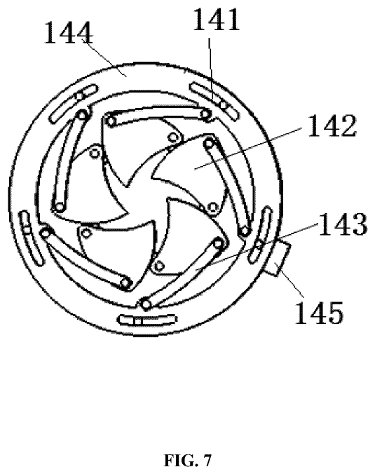

As shown in FIGS. 6 and 7, the slidable rotating cover 14 includes sliders 141, fan blades 142, connecting rods 143, a base 144, and a micro rotary motor 145. The base 144 serves as a “foundation” of the entire mechanism. The base 144 is provided with machined sliding grooves to guide the sliders 141. The sliders 141 are embedded in the sliding grooves of the base 144 and can only perform reciprocating arc motion along the grooves. A fixed hinge point is provided at one end of the each of the sliders 141 for installing a rotating shaft of the fan blade 142. The root of the fan blade 142 is mounted on the fixed hinge point of the base 144 via a rotating shaft perpendicular to the base 144, allowing 0-90° rotation around this axis. The other side of the fan blade 142 is provided with a second hinge ear, which is hinged to the other end of the connecting rod 143. When the slider 141 moves, the connecting rod 143 converts the arc displacement into angular position changes of the fan blade 142. The micro rotary motor 145 is typically connected to the slider 141 through a screw-nut pair or a gear-rack pair, with a motor output shaft (screw or gear) meshing with the nut/rack of the slider 141 to directly convert the rotary motion of the motor into linear motion of the slider 141.

For example, when significant stratum deformation occurs, the multi-stage telescopic structure comes into play to ensure contact. When the telescopic rod 13 of the entire strain sensor 1 can no longer extend further, it indicates that the FBG sensor 11 have contacted the slip zone stratum. At this point, the slidable rotating cover 14 can be automatically opened through the data control module 2. If contact is not achieved, the telescopic rod 13 can be further adjusted to make the FBG sensor 11 contact the slip zone stratum.

The data control module 2 is arranged on a surface of the landslide body 7 and is electrically connected to switch of the slidable rotating cover 14 via data cable 22. The data control module 2 can preprocess data collected by the FBG sensor 11, store the data in a local database, and then transmit the data to a remote monitoring center. This configuration facilitates maintenance and power supply while achieving data acquisition, local storage, and remote transmission.

The magnetic positioning device 3 is used to correct displacement detection orientation errors of the FBG sensor 11 caused by landslide deformation. Through magnetic field positioning technology, the orientation deviation of the FBG sensor 11 caused by overall landslide displacement is corrected in real time, solving the “displacement-strain coupling” error problem in traditional strain monitoring.

Specifically, in this embodiment, the apparatus achieves dynamic three-dimensional strain monitoring of the landslide slip zone through layered deployment and modular design. The apparatus is deployed partially in the landslide body 7 and partially in the slip zone 8, with the bedrock layer 9 below the slip zone 8. This location selection directly targets a key shear zone (slip zone) of landslide hazards, ensuring that monitoring data can reflect a core area of landslide deformation.

During data acquisition and processing, the data control module 2 commands the slidable rotating cover 14 to open, and the telescopic rod 13 pushes the FBG sensor 11 to be in contact with the slip zone stratum to initiate strain monitoring. Strain data from the FBG sensor 11 is transmitted to the data control module 2 via the data cable 22, preprocessed, stored in the local database, and then uploaded to the remote monitoring center via wireless communication (e.g., 4G/satellite). The magnetic positioning device 3 outputs sensor spatial orientation data in real time. The data control module 2 combines the original strain data with orientation correction values to generate a corrected three-dimensional strain field.

It should be noted that the telescopic rod 13 allows the sensor to maintain effective contact under varying slip zone thicknesses or deformation stages (such as slip zone dilation), preventing monitoring interruptions caused by stratum displacement. The switching mechanism of the slidable rotating cover 14 serves to protect the sensor by closing during non-monitoring periods and opening during monitoring, balancing equipment lifespan with data continuity.

Understandably, the FBG sensor 11 can detect micron-level strain changes in the slip zone, enabling early identification of initial landslide deformation signals. The orientation correction by magnetic positioning eliminates “pseudo-strain” errors in traditional strain monitoring caused by overall sensor displacement, ensuring that strain data accurately reflects local deformation in the slip zone and significantly improving monitoring accuracy.

Furthermore, the design of the protective shell and slidable rotating cover prevents sensor damage from environmental factors such as groundwater erosion and soil friction, extending equipment lifespan in harsh geological conditions. The telescopic rod 13 can adapt to dynamic changes in slip zone thickness (for example, water-induced expansion during rainy seasons), maintaining stable contact between the sensor and the stratum.

The data control module 2 performs preliminary local filtering and noise reduction on the collected data, reducing the data volume for remote transmission and improving system response speed. The apparatus achieves reliable, long-term, real-time monitoring of three-dimensional strains in landslide slip zones, providing critical data support for early warning of geological disasters.

Further, in an embodiment of the present disclosure, a plurality of FBG sensors 11 are arranged in the slip zone 8 along axial, 45° oblique, and transverse orthogonal directions, and a calculation expression for a relationship between strains measured by the FBG sensor 11 and wavelengths is as follows:

$$\{ \begin{matrix}Δ {λ}_{1} = {K}_{11} {ε}_{x} + {K}_{12} {ε}_{y} + {K}_{13} {Υ}_{xy} \\ Δ {λ}_{2} = {K}_{21} {ε}_{x} + {K}_{22} {ε}_{y} + {K}_{23} {Υ}_{xy} \\ Δ {λ}_{3} = {K}_{31} {ε}_{x} + {K}_{32} {ε}_{y} + {K}_{33} {Υ}_{xy}\end{matrix}$$

where Δλ₁ represents a wavelength change detected by the FBG sensors arranged along the axial direction; Δλ₂ represents a wavelength change detected by the FBG sensors arranged along the 45° oblique direction; Δλ₃ represents a wavelength change detected by the FBG sensors arranged along the transverse orthogonal direction; K₁₁, K₁₂, and K₁₃ are coefficients corresponding to the FBG sensors arranged along the axial direction; K₂₁, K₂₂, and K₂₃ are coefficients corresponding to the FBG sensors arranged along the 45° oblique direction; K₃₁, K₃₂, and K₃₃ are coefficients corresponding to the FBG sensors arranged along the transverse orthogonal direction; εₓ represents a tensile/compressive strain of the slip zone along a sensor axial direction; ε_{y} represents a normal strain of the slip zone along a direction perpendicular to a main sliding direction; and γ_{xy} represents a shear strain of the slip zone in an x-y plane.

Specifically, the sensor arrangement and coordinate system are defined as follows:

Axial direction (0°): Along a principle stress direction (x-axis), measuring normal strain εₓ.

Transverse direction (90°): Perpendicular to the principal stress direction (y-axis), measuring normal strain ε_{y}.

45° oblique direction: At 45° to the x-axis, measuring coupled shear strain γ_{xy} and normal strain combination.

By measuring wavelength shifts Δλᵢ in three directions, independent strain components can be determined.

This solution establishes a three-dimensional strain-sensitive network through orthogonally arranged FBG sensors 11, achieving precise decoupling of strain components using a direction cosine matrix, overcoming the limitation of traditional FBG single-axis strain measurement and enabling three-dimensional strain measurement.

Further, in one embodiment of the present disclosure, a calculation expression for a three-dimensional strain tensor is as follows:

$$ε = [ \begin{matrix}{ε}_{x} & {η}_{xy} & {η}_{x z} \\ {η}_{x y} & {ε}_{y} & {η}_{y z} \\ {η}_{x z} & {η}_{yz} & {ε}_{z}\end{matrix} ]$$

where ηᵢⱼ (ij=xy, xz, yz) represent shear strains in an ij direction; and ε_{z} represents a normal strain of the slip zone along a z-axis direction.

This solution incorporates shear strain γ_{xy} as an independent variable into calculations through the definition of three-dimensional strain tensor, avoiding strength evaluation errors caused by neglecting the shear strain, and directly correlating the shear strain with structural damage.

Further, in one embodiment of the present disclosure, a strain-to-stress conversion formula based on the strains measured by the FBG sensors 11 is expressed as follows:

$$[ \begin{matrix}{σ}_{x} \\ {σ}_{y} \\ {σ}_{z} \\ {τ}_{x y} \\ {τ}_{y z} \\ {τ}_{zx}\end{matrix} ] = \frac{E}{( 1 + v ) ( 1 - 2 v )} [ \begin{matrix}1 - v & v & v & 0 & 0 & 0 \\ v & 1 - v & v & 0 & 0 & 0 \\ v & v & 1 - v & 0 & 0 & 0 \\ 0 & 0 & 0 & \frac{1 - 2 v}{2} & 0 & 0 \\ 0 & 0 & 0 & 0 & \frac{1 - 2 v}{2} & 0 \\ 0 & 0 & 0 & 0 & 0 & \frac{1 - 2 v}{2}\end{matrix} ] [ \begin{matrix}{ε}_{x} \\ {ε}_{y} \\ {ε}_{z} \\ {γ}_{x y} \\ {γ}_{y z} \\ {γ}_{zx}\end{matrix} ]$$

where σₓ represents a normal stress along an x-axis direction; σ_{y} represents a normal stress along a y-axis direction; σ_{z} represents a normal stress along a z-axis direction; τ_{xy} represents a shear stress in the x-y plane; τ_{yz} represents a shear stress in a y-z plane; τ_{zx} represents a shear stress in a z-x plane; E represents an elastic modulus; v represents Poisson's ratio (a ratio of transverse contraction to axial elongation); γ_{yz} represents a shear strain of the slip zone in a y-z plane; and γ_{zx} represents a shear strain of the slip zone in a z-x plane.

This matrix expression represents the generalized Hooke's law (stress-strain relationship) for three-dimensional linear elastic materials, using engineering shear strain representation. This embodiment directly calculates six stress components from six strain components (σₓ, σ_{y}, σ_{z}, τ_{xy}, τ_{yz}, τ_{zx}) measured by the FBG sensors 11, without requiring additional assumptions (such as plane stress/strain).

Thus, this expression converts macroscopic strain measurements into a three-dimensional stress field through elastic constitutive relations, overcoming traditional simplified assumptions (such as plane stress) and being suitable for complex loading conditions. It directly correlates shear stress τᵢⱼ with material strength criteria (such as maximum shear stress theory), providing a consistent verification standard for microscale FBG data and macroscopic finite element models.

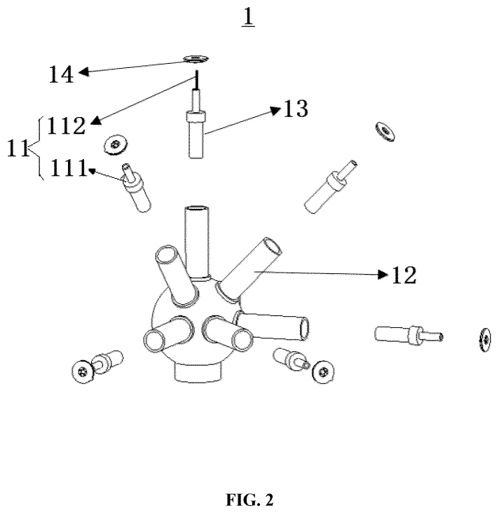

Specifically, referring to FIG. 2, the FBG sensor 11 includes a cladding 111 and a core 112 located within the cladding 111. The cladding 111 is designed as a protective structure with an outer layer, a middle layer, and an inner layer. The inner layer is coated with acrylate to achieve resistance against microbending loss. The middle layer is encapsulated with a stainless steel capillary to reduce shear damage effects. The outer layer is covered with a polyurethane sheath to provide resistance against acid and alkali corrosion.

Thus, through the three-layer progressive protection of “acrylate for microbending reduction, stainless steel for shear resistance, and polyurethane for corrosion resistance,” combined with a high-sensitivity germanium-doped quartz core, the sensor maintains an accuracy of <±2 pm while achieving long-term stable monitoring in extreme working conditions involving high shear, high corrosion, and high vibration.

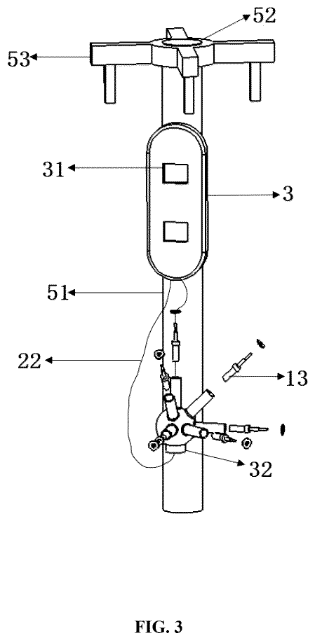

Specifically, referring to FIG. 1 and FIG. 3, the apparatus further includes a fixed casing 4 and a support structure 5.

During installation, the landslide body 7 is provided with a borehole 71 along a vertical direction, and the fixed casing 4 is vertically installed within the borehole 71. The borehole 71 penetrates vertically through the landslide body 7 to reach the slip zone 8/bedrock layer 9, forming a guide hole of a specific diameter. Preferably, the fixed casing 4 in this embodiment is made of a polyvinyl chloride (PVC) or stainless steel pipe, with an outer diameter slightly smaller than that of the borehole 71, and is fixed by grouting.

The support structure 5 includes a support column 51, a limit ring 52, a support frame 53, and a support rod 54. The support column 51 is vertically inserted into the fixed casing 4. The limit ring 52 is sleeved on a top of the support column 51. The support frame 53 is uniformly and perpendicularly connected around a periphery of the limit ring 52 as an integral part. The support rod 54 is parallel to the support column 51, with top end vertically connected to a bottom surface of the support frame 53. The top of the support column 51 is fixed to a ground surface of the landslide body 7 via the limit ring 52, while a bottom end of the support column 51 extends into the slip zone 8 and is anchored in the bedrock layer 9. The support frame 53 is fixed to the ground surface of the landslide body 7 via the support rod 54. The FBG sensor 11 is fixed to the support column 51.

In this embodiment, the limit ring 52 is fixed to the ground surface of the landslide body 7 via anchor bolts to restrict lateral displacement at the top. The support frame is welded to the limit ring 52 as an integral part to provide a horizontal reference plane, while the support rod 54 prevents swinging of the support column 51. Through the arrangement of the fixed casing 4 and the support structure 5, the FBG sensor is firmly implanted into the deep part of the landslide body, ensuring that minor strains induced by the landslide are accurately transmitted to the sensor. This ultimately achieves long-term, stable, millimeter-level monitoring of the position, slip rate, and three-dimensional strain field of the slip zone 8.

Preferably, the support column 51 is made of reinforced concrete material. The support column 51 can effectively prevent excessive position changes of the strain sensor 1 and the magnetic positioning device 3 when internal deformation occurs in the landslide body 7.

Specifically, referring to FIG. 3, the magnetic positioning device 3 includes a fluxgate sensor 31 and a magnetic pole 32 electrically connected to each other. The fluxgate sensor 31 is fixedly installed on the support column 51 and is located directly above the FBG sensor 11, while the magnetic pole 32 is fixed at bottoms of the FBG sensor 11.

Thus, by utilizing magnetic field characteristics, precise spatial positioning information is provided for the strain sensor 1. Simultaneously, in coordination with the data control module 2, when deformation occurs in the slip zone 8, the position of the strain sensor 1 can be corrected, reducing interference from landslide deformation on strain measurements.

Specifically, referring to FIG. 1 and FIG. 3, the data control module 2 includes a data box 21 and data interfaces 23 embedded in the data box 21. When network issues occur in the data box 21, data storage devices can be connected to the data interfaces 23 for data copying, facilitating subsequent queries and analysis. The data box 21 is electrically connected to the strain sensor 1 and the magnetic positioning device 3 via the data cable 22.

In this embodiment, the data box 21 is connected to the strain sensor 1 and the magnetic positioning device 3 via the data cable 22. The data control module 2 primarily undertakes core tasks of data processing, storage, and transmission. It receives raw data from the strain sensor 1, applies specific algorithms for preprocessing such as filtering and calibration, stores the processed data in a local database, and promptly transmits the data to a remote monitoring center via network.

Additionally, the data control module 2 can monitor and manage the operational status of the entire monitoring apparatus, control working modes of the strain sensor 1 and the magnetic positioning device 3, adjust a data acquisition frequency, and ensure stable operation of the monitoring system.

Specifically, referring to FIG. 1, the apparatus further includes a solar panel 6 installed on a top of the data control module 2. The solar panel 6 is electrically connected to the data control module 2, converting solar energy into electrical energy and storing the electrical energy in a battery inside the data control module 2, thereby providing power support for all components of the apparatus and enhancing operational continuity of the apparatus.

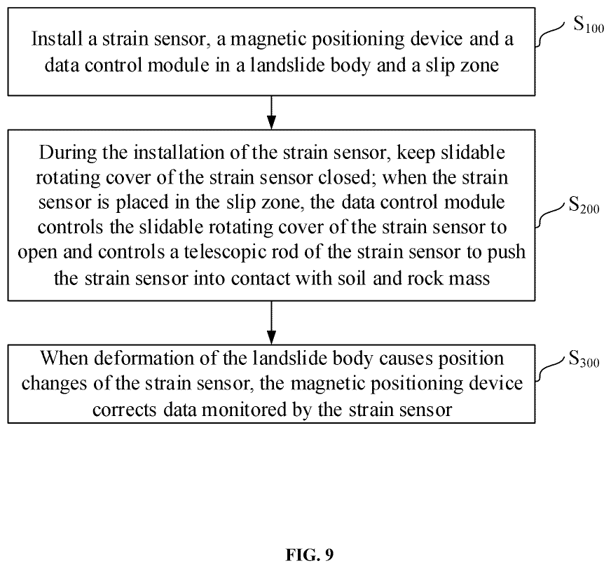

Referring to FIG. 9, another embodiment of the present disclosure further provides a monitoring method applicable to the aforementioned apparatus for monitoring three-dimensional strain in the landslide slip zone. The monitoring method includes the following steps:

In step S₁₀₀, the strain sensor, the magnetic positioning device, and the data control module are installed in the landslide body and the slip zone.

In this step, calibration tests are first conducted on the strain sensor 1 and the magnetic positioning device 3. After calibration, based on geological survey data of the slip zone 8, a borehole is drilled in a key area of the landslide body 7, and the fixed casing 4 is installed in the borehole 71. The data control module 2 is installed on the surface of the landslide body 7 and connected to the strain sensor 1 and the magnetic positioning device 3 via the data cable 22. The strain sensor 1 and the magnetic positioning device 3 are fixed on an outer surface of the support column 51, with the strain sensor 1 positioned within the slip zone 8.

In step S₂₀₀, during the installation of the strain sensor 1, the slidable rotating cover 14 of the strain sensor 1 are kept closed. When the strain sensor 1 is placed in the slip zone 8, the data control module 2 controls the slidable rotating cover 14 of the strain sensor 1 to open and controls the telescopic rod 13 of the strain sensor 1 to push the strain sensor 1 into contact with the soil and rock mass.

In this step, after the support rod 54 and the strain sensor 1 are properly positioned, backfilling is performed on the borehole 71 to maintain the stable relative position of the monitoring apparatus.

Thus, through a two-stage electromechanical actuator system including the slidable rotating cover 14 and telescopic rod 13, the entire process of lowering, positioning, and pushing into contact with the soil and rock mass for the strain sensor 1 is automated, sealed and force-controlled, significantly reducing installation damage and sediment-related failures while improving first-time success rate. Real-time coordination with the control module, magnetic positioning, and FBG ensures “in-situ, seamless, high-precision” strain monitoring of the soil and rock mass in the slip zone.

In step S₃₀₀, when deformation of the landslide body causes position changes of the strain sensor, the magnetic positioning device corrects data monitored by the strain sensor.

In this step, if the telescopic rod 13 of the strain sensor 1 fails to contact the soil and rock mass in the slip zone 8, the data control module 2 controls the telescopic rod 13 to establish contact with the soil and rock mass. Upon reaching maximum extension, the data control module 2 retracts the telescopic rod 13 and performs data correction.

Thus, the telescopic rod 13 can freely extend/retract according to deformation of the soil and rock mass while transmitting data to the data control module 2 in real time. This method fully integrates the advantages of the three-dimensional strain sensor, data control, magnetic positioning device, protective device, and multi-stage telescopic structure to effectively conduct three-dimensional strain monitoring of landslide slip zones.

Although the present disclosure is disclosed as described above, the protection scope of the present disclosure is not limited thereto. Those skilled in the art can make various changes and modifications without departing from the spirit and scope of the present disclosure. Such changes and modifications shall fall within the protection scope of the present disclosure.

What is claimed is:

1. An apparatus for monitoring three-dimensional strain in a landslide slip zone, wherein the apparatus is configured to be installed partially in a landslide body and partially in the slip zone, the slip zone is located just below the landslide body, and a bedrock layer is situated below the slip zone, and the apparatus comprises:
a strain sensor comprising a protective shell, a slidable rotating cover covering an opening of the protective shell, a fiber Bragg grating (FBG) sensor located inside the protective shell, and a telescopic rod slidably arranged within the protective shell and the slidable rotating cover, wherein the telescopic rod is configured to push the FBG sensor into contact with a stratum to monitor strain information of soil and rock mass in the slip zone;
a data control module configured to be arranged on a surface of the landslide body, wherein the data control module is electrically connected to a switch of the slidable rotating cover via a data cable; the data control module is configured to preprocess data collected by the FBG sensor, save the data in a local database, and transmit the data to a remote monitoring center; and
a magnetic positioning device configured to correct displacement detection orientation errors of the FBG sensor caused by landslide deformation.

2. The apparatus according to claim 1, wherein a plurality of FBG sensors are respectively arranged in the landslide body along axial, 45° oblique, and transverse orthogonal directions, and a calculation expression for a relationship between strains measured by the plurality of FBG sensors and wavelengths is as follows:
$$\{ \begin{matrix}Δ {λ}_{1} = {K}_{11} {ε}_{x} + {K}_{12} {ε}_{y} + {K}_{13} {Υ}_{xy} \\ Δ {λ}_{2} = {K}_{21} {ε}_{x} + {K}_{22} {ε}_{y} + {K}_{23} {Υ}_{xy} \\ Δ {λ}_{3} = {K}_{31} {ε}_{x} + {K}_{32} {ε}_{y} + {K}_{33} {Υ}_{xy}\end{matrix}$$
wherein Δλ₁ represents a wavelength change detected by the FBG sensors arranged along the axial direction; Δλ₂ represents a wavelength change detected by the FBG sensors arranged along the 45° oblique direction; Δλ₃ represents a wavelength change detected by the FBG sensors arranged along the transverse orthogonal direction; K₁₁, K₁₂, and K₁₃ are coefficients corresponding to the FBG sensors arranged along the axial direction; K₂₁, K₂₂, and K₂₃ are coefficients corresponding to the FBG sensors arranged along the 45° oblique direction; K₃₁, K₃₂, and K₃₃ are coefficients corresponding to the FBG sensors arranged along the transverse orthogonal direction; εₓ represents a tensile/compressive strain of the slip zone along a sensor axial direction; ε_{y} represents a normal strain of the slip zone along a direction perpendicular to a main sliding direction; and γ_{xy} represents a shear strain of the slip zone in an x-y plane.

3. The apparatus according to claim 2, wherein a calculation expression for a three-dimensional strain tensor is as follows:
$$ε = [ \begin{matrix}{ε}_{x} & {η}_{xy} & {η}_{x z} \\ {η}_{x y} & {ε}_{y} & {η}_{y z} \\ {η}_{x z} & {η}_{yz} & {ε}_{z}\end{matrix} ]$$
wherein η_{xy}, η_{xz}, and η_{yz} represent shear strains in an ij direction; and ε_{z} represents a normal strain of the slip zone along a z-axis direction.

4. The apparatus according to claim 3, wherein a strain-to-stress conversion formula based on the strains measured by the plurality of FBG sensors is expressed as follows:
$$[ \begin{matrix}{σ}_{x} \\ {σ}_{y} \\ {σ}_{z} \\ {τ}_{x y} \\ {τ}_{y z} \\ {τ}_{zx}\end{matrix} ] = \frac{E}{( 1 + v ) ( 1 - 2 v )} [ \begin{matrix}1 - v & v & v & 0 & 0 & 0 \\ v & 1 - v & v & 0 & 0 & 0 \\ v & v & 1 - v & 0 & 0 & 0 \\ 0 & 0 & 0 & \frac{1 - 2 v}{2} & 0 & 0 \\ 0 & 0 & 0 & 0 & \frac{1 - 2 v}{2} & 0 \\ 0 & 0 & 0 & 0 & 0 & \frac{1 - 2 v}{2}\end{matrix} ] [ \begin{matrix}{ε}_{x} \\ {ε}_{y} \\ {ε}_{z} \\ {γ}_{x y} \\ {γ}_{y z} \\ {γ}_{zx}\end{matrix} ]$$
wherein σₓ represents a normal stress along an x-axis direction; σ_{y} represents a normal stress along a y-axis direction; σ₂ represents a normal stress along a z-axis direction; τ_{xy} represents a shear stress in the x-y plane; τ_{yz} represents a shear stress in a y-z plane; τ_{zx} represents a shear stress in a z-x plane; E represents an elastic modulus; v represents Poisson's ratio; γ_{yz} represents a shear strain of the slip zone in a y-z plane; and γ_{zx} represents a shear strain of the slip zone in a z-x plane.

5. The apparatus according to claim 1, wherein the FBG sensor comprises a cladding and a core located inside the cladding, the cladding is designed as a protective structure with an outer layer, a middle layer, and an inner layer, the inner layer is coated with acrylate, the middle layer is encapsulated with a stainless steel capillary, and the outer layer is covered with a polyurethane sheath.

6. The apparatus according to claim 1, further comprising:
a fixed casing configured to be vertically installed in a borehole vertically defined in the landslide body; and
a support structure comprising a support column vertically inserted into the fixed casing, a limit ring sleeved on a top of the support column, a support frame uniformly and perpendicularly connected around a periphery of the limit ring as an integral part, and a support rod parallel to the support column, with a top end vertically connected to a bottom surface of the support frame, wherein the top of the support column is fixed to a ground surface of the landslide body via the limit ring, a bottom end of the support column extends into the slip zone and is fixed in the bedrock layer; the support frame is fixed to the ground surface of the landslide body via the support rod; and the FBG sensor is fixed on the support column.

7. The apparatus according to claim 6, wherein the magnetic positioning device comprises a fluxgate sensor and a magnetic pole electrically connected to each other, the fluxgate sensor is fixed on the support column and is located directly above the FBG sensor, and the magnetic pole is fixed at a bottom of the FBG sensor.

8. The apparatus according to claim 1, wherein the data control module comprises a data box and a data interface embedded in the data box, the data box is electrically connected to the strain sensor and the magnetic positioning device via a data cable.

9. The apparatus according to claim 1, further comprising a solar panel installed on a top of the data control module, wherein the solar panel is electrically connected to the data control module.

10. A method applied to the apparatus for monitoring three-dimensional strain in the landslide slip zone according to claim 1, comprising the following steps:
step S₁₀₀: installing the strain sensor, the magnetic positioning device, and the data control module in the landslide body and the slip zone;
step S₂₀₀: during the installation of the strain sensor, keeping the slidable rotating cover of the strain sensor closed, wherein when the strain sensor is placed in the slip zone, the data control module controls the slidable rotating cover of the strain sensor to open and controls the telescopic rod of the strain sensor to push the strain sensor into contact with the soil and rock mass; and
step S₃₀₀: when deformation of the landslide body causes position changes of the strain sensor, correcting, by the magnetic positioning device, data monitored by the strain sensor.
